(19) United States
(12) Patent Application Publication
(10) Pub. No.: US 2024/0198155 A1
(43) Pub. Date: Jun. 20, 2024

(54) SPRINKLER HEAD FOR A FIRE DETECTION SYSTEM AND A METHODTHEREOF

(71) Applicant: Marioff Corporation Oy, Vantaa (FI)

(72) Inventor: Nazar Krutskevych, Gdansk (PL)

(21) Appl. No.: 18/545,197

(22) Filed: Dec. 19, 2023

Related U.S. Application Data
(60) Provisional application No. 63/476,173, filed on Dec. 20, 2022.

(51) Int. Cl. A62C 37/12; A62C 31/02

(52) U.S. Cl. CPC A62C 37/12; A62C 31/02

(57) ABSTRACT

A sprinkler head includes a sprinkler body and a frangible sprinkler bulb connected to the sprinkler body. The frangible sprinkler bulb includes a resistive track embedded in a cylindrical wall. A microchip and a diode are operationally connected in series to the resistive track. The microchip and the diode are connected in parallel to each other. In a tracking mode, a first current flows from a first terminal to a second terminal sequentially through the resistive track and the microchip. In a releasing mode, a second current flows from the second terminal to the first terminal sequentially through the diode and the resistive track.

### CROSS REFERENCE TO A RELATED APPLICATION

The application claims the benefit of U.S. Provisional Application No. 63/476,173 filed Dec. 20, 2022, the contents of which are hereby incorporated in their entirety.

### FIELD OF THE INVENTION

The disclosure generally relates to sprinkler heads for fire detection systems. More particularly, the disclosure relates to a sprinkler head adapted to operate in a tracking mode and a releasing mode in a fire detection system.

### BACKGROUND

Fire detection systems include sprinkler devices arranged to expel or disperse fluid for suppressing or preventing fire. Fire detection systems are typically connected to a water supply system providing sufficient pressure and flowrate to water within a network of pipes. Sprinkler devices are mounted onto the pipes at different locations within a room. Sprinkler devices are preferably spaced apart and ensure all areas within the building are covered. Each of the sprinkler devices typically includes sprinkler bulbs that are frangible and rupture at predetermined temperatures. The increase in ambient temperature raises the temperature of a liquid within the frangible bulb causing the liquid to expand. When the pressure within the frangible bulb expands beyond a threshold pressure due to expansion of the liquid, the frangible bulb ruptures thereby causing the sprinkler device to emit fire suppression fluid. Therefore, sprinkler bulbs operate as a type of mechanical fuse, which releases fire suppression fluid from an associated source when they break.

Existing fire detection systems employ sprinkler bulbs that wirelessly transmit information from such bulbs. The information received from the bulbs helps fire detection systems to identify which sprinkler bulbs are ruptured and accordingly identify a fire location. Existing fire sprinkler bulbs with integrated remote activation functionality have no embedded digital tracking capabilities and therefore, limiting their use. Since sprinkler bulbs are typically small, frangible, single-use components of the fire detection system, complexity, and cost of the components used for tracking and activation of the sprinkler bulbs reduce their applicability. Improvements to fire detection systems employing sprinkler bulbs having improved tracking and activation features without increasing complexity or cost of implementation are therefore desirable.

### SUMMARY

This summary is provided to introduce a selection of concepts in a simplified format that are further described in the detailed description of the invention. This summary is not intended to identify key or essential inventive concepts of the invention, nor is it intended for determining the scope of the invention.

Disclosed herein is a sprinkler head including a sprinkler body and a frangible sprinkler bulb connected to the sprinkler body. The frangible sprinkler bulb includes a resistive track embedded in a cylindrical wall. At least one microchip and at least one diode are operationally connected in series to the resistive track. Further, the at least one microchip and the at least one diode are connected in parallel to each other. In a tracking mode, a first current flows from a first terminal to a second terminal sequentially through the resistive track and the at least one microchip. In a releasing mode, a second current flows from the second terminal to the first terminal sequentially through the at least one diode and the resistive track.

In one or more embodiments, the sprinkler head further includes a mounting adaptor for connecting with a supply conduit.

In one or more embodiments, the sprinkler head, further includes a seal for fluidly isolating the frangible sprinkler bulb from the supply conduit.

In one or more embodiments, the resistive track is embedded in the cylindrical wall in a pattern including at least one of a serpentine pattern, a periodic waveform pattern, a waveform pattern, and a helical pattern.

In one or more embodiments, in the releasing mode, the second current passing through the embedded resistive track disintegrates the frangible sprinkler bulb.

Also disclosed herein is a fire detection system including the sprinkler head and a control circuitry. The sprinkler head includes a sprinkler body and a frangible sprinkler bulb connected to the sprinkler body. The frangible sprinkler bulb includes a resistive track embedded in a cylindrical wall. At least one microchip and at least one diode are operationally connected in series to the resistive track. Further, the at least one microchip and the at least one diode are connected in parallel to each other. The control circuitry is configured to communicate, during the tracking mode, with the at least one microchip in the frangible sprinkler bulb to obtain information related to the frangible sprinkler bulb. The information includes at least one of a location of the frangible sprinkler bulb, a temperature of a region surrounding the frangible sprinkler bulb, smoke particulate density of the region surrounding the frangible sprinkler bulb, and a resistance of the resistive track.

In one or more embodiments, the control circuitry is configured to communicate, during the releasing mode, with the at least one microchip in the frangible sprinkler bulb to trigger the second current based on the determined resistance of the resistive track.

In one or more embodiments, the resistive track is embedded in the cylindrical wall in a pattern comprising at least one of a serpentine pattern, a periodic waveform pattern, a waveform pattern, and a helical pattern.

In one or more embodiments, the releasing mode is triggered based on the control circuitry receiving an input.

In one or more embodiments, the releasing mode is triggered based on the control circuitry identifying the obtained information exceeding at least one predefined criteria.

In one or more embodiments, the control circuitry is further configured to detect a fire event based on the control circuitry receiving absence of response from the at least one microchip during the tracking mode.

In one or more embodiments, the tracking mode is triggered periodically at predefined intervals.

In one or more embodiments, the tracking mode is triggered based on the control circuitry receiving an input.

In one or more embodiments, the control circuitry is further configured to generate a notification on a computing device based on at least one of triggering of the releasing mode and detection of the fire event.

In one or more embodiments, the notification is one of an audio notification, a visual notification, and audio-visual notification, and a haptic notification.

Also disclosed herein is a fire detection method. The method includes the step of providing a fire detection system including a sprinkler head and control circuitry. The sprinkler head includes a sprinkler body and a frangible sprinkler bulb connected to the sprinkler body. The frangible sprinkler bulb includes a resistive track embedded in a cylindrical wall. At least one microchip and at least one diode are operationally connected in series to the resistive track. Further, the at least one microchip and the at least one diode are connected in parallel to each other. The control circuitry communicates with the at least one microchip of the frangible sprinkler bulb. Next, the control circuitry, during a tracking mode, obtains information related to the frangible sprinkler bulb. In one or more embodiments, the information includes at least one of a location of the frangible sprinkler bulb, a temperature of a region surrounding the frangible sprinkler bulb, smoke particulate density of the region surrounding the frangible sprinkler bulb, and a resistance of the resistive track. Finally, the control circuitry detects, during the tracking mode, a fire event based on the control circuitry receiving absence of response from the at least one microchip during the tracking mode.

In one or more embodiments, the method includes the step of providing a fire detection system including a sprinkler head and control circuitry. The sprinkler head includes a sprinkler body and a frangible sprinkler bulb connected to the sprinkler body. The frangible sprinkler bulb includes a resistive track embedded in a cylindrical wall. At least one microchip and at least one diode are operationally connected in series to the resistive track. Further, the at least one microchip and the at least one diode are connected in parallel to each other. the fire detection method includes the control circuitry of the fire detection system communicating with the at least one microchip of the frangible sprinkler bulb. Next, the control circuitry, during a tracking mode, obtains information related to the frangible sprinkler bulb. In one or more embodiments, the information includes at least one of a location of the frangible sprinkler bulb, a temperature of a region surrounding the frangible sprinkler bulb, smoke particulate density of the region surrounding the frangible sprinkler bulb, and a resistance of the resistive track. Finally, the control circuitry detects, during the tracking mode, a fire event based on the control circuitry identifying the obtained information exceeding at least one predefined criteria.

In one or more embodiments, the control circuitry is further configured to trigger a releasing mode based on the control circuitry identifying the obtained information exceeding the at least one predefined criteria.

In one or more embodiments, the releasing mode is triggered based on the control circuitry receiving an input. In one or more embodiments, the control circuitry is further configured to generate a notification on a computing device based on triggering of the releasing mode or detection of the fire event.

In one or more embodiments, the notification includes an audio notification, a visual notification, an audio-visual notification, and a haptic notification.

To further clarify the advantages and features of the method and system, a more particular description of the method and system will be rendered by reference to specific embodiments thereof, which is illustrated in the appended drawing. It is appreciated that these drawings depict only typical embodiments of the invention and are therefore not to be considered limiting its scope. The invention will be described and explained with additional specificity and detail with the accompanying drawings.

### BRIEF DESCRIPTION OF THE DRAWINGS

These and other features, aspects, and advantages will become better understood when the following detailed description is read with reference to the accompanying drawings in which like characters represent like parts throughout the drawings, wherein:

FIG. 1A exemplarily illustrates a sectional view of a sprinkler head according to one or more embodiments;

FIG. 1B exemplarily illustrates an isometric view of a frangible sprinkler bulb of the sprinkler head shown in FIG. 1A, in accordance with one or more embodiments of the disclosure.

FIG. 1C exemplarily illustrates a circuit diagram showing the frangible sprinkler bulb operating in a tracking mode, in accordance with one or more embodiments of the disclosure.

FIG. 1D exemplarily illustrates a circuit diagram showing the frangible sprinkler bulb operating in a releasing mode, in accordance with one or more embodiments of the disclosure.

FIG. 2 exemplarily illustrates a schematic block diagram showing an implementation of a fire detection system, in accordance with one or more embodiments of the disclosure.

FIG. 3A exemplarily illustrates a flowchart indicating a fire detection method using the fire detection system shown in FIG. 2, in accordance with one or more embodiments of the disclosure.

FIG. 3B exemplarily illustrates a flowchart indicating a fire detection method using the fire detection system shown in FIG. 2, in accordance with one or more embodiments of the disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the invention. Furthermore, in terms of the construction of the device, one or more components of the device may have been represented in the drawings by conventional symbols, and the drawings may show only those specific details that are pertinent to understanding the embodiments of the invention so as not to obscure the drawings with details that will be readily apparent to those of ordinary skill in the art having the benefit of the description herein.

### DETAILED DESCRIPTION

It should be understood at the outset that although illustrative implementations of embodiments are illustrated below, system and method may be implemented using any number of techniques. The disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “one, or more than one, or all.” Accordingly, the terms “one,” “more than one,” but not all” or “all” would all fall under the definition of “some.” The term “some embodiments” May refer to no embodiments or one embodiment or several embodiments or all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises,” “has,” “have” and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “must comprise” or “needs to include.”

The term “unit” used herein may imply a unit including, for example, one of hardware, software, and firmware or a combination of two or more of them. The “unit” may be interchangeably used with a term such as logic, a logical block, a component, a circuit, and the like. The “unit” May be a minimum system component for performing one or more functions or may be a part thereof.

Unless otherwise defined, all terms, and especially any technical and/or scientific terms, used herein may be taken to have the same meaning as commonly understood by one having ordinary skill in the art.

Embodiments will be described below in detail with reference to the accompanying drawings.

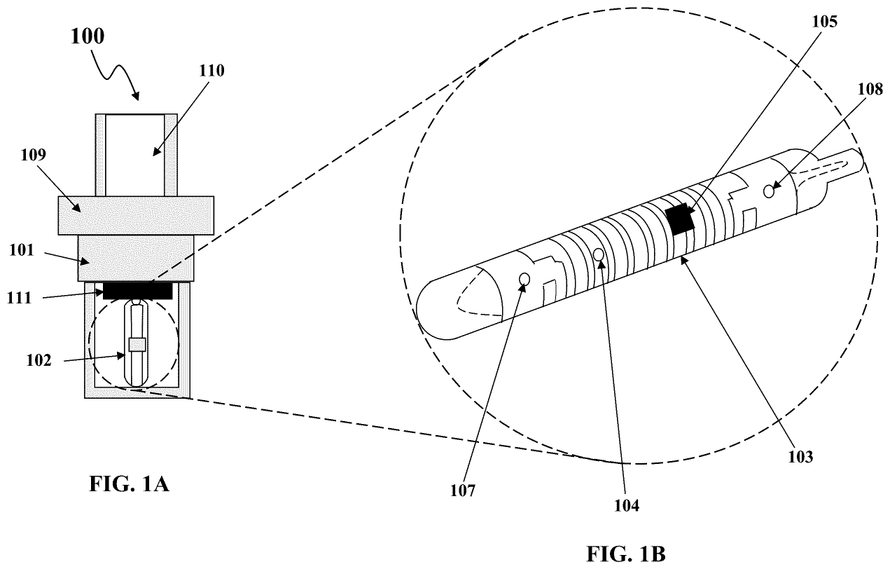

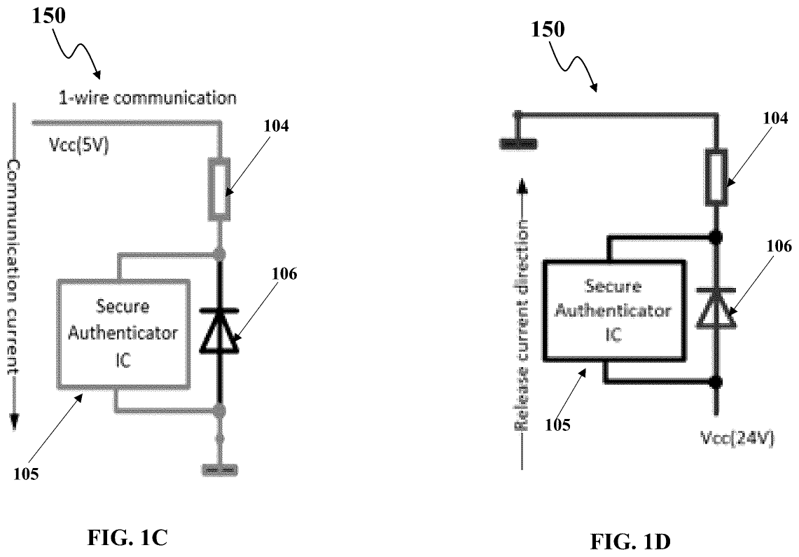

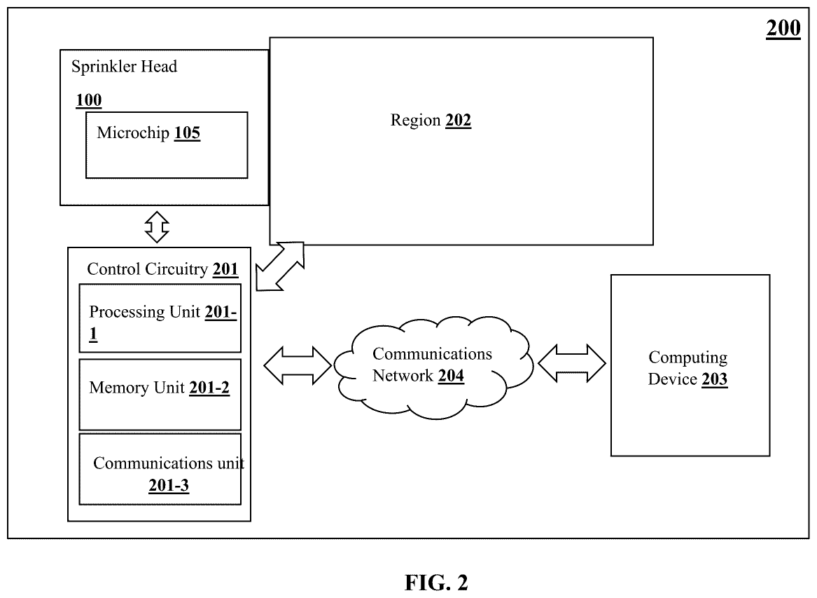

FIG. 1A exemplarily illustrates a sprinkler head 100 comprising a sprinkler body 101 and a frangible sprinkler bulb 102 connected to the sprinkler body 101. As used herein, the “frangible sprinkler bulb 102” refers to a heat sensitive glass bulb configured to store a liquid. The liquid within the frangible sprinkler bulb 102 expands with increase in temperature of a region 202 (shown in FIG. 2) surrounding the frangible sprinkler bulb 102. When the activation temperature or the temperature at which the frangible sprinkler bulb 102 is designed to rupture is reached, the frangible sprinkler bulb 102 disintegrates. In one or more embodiments, the liquid stored within the frangible sprinkler bulb 102 is colour coded to indicate a temperature rating or the design temperature at which the frangible sprinkler bulb 102 will rupture. The frangible sprinkler bulb 102 breaks because of the thermal expansion of the liquid inside the frangible sprinkler bulb 102. The time taken until the frangible sprinkler bulb 102 breaks is dependent on the temperature of the surrounding region 202. Below the design temperature, the frangible sprinkler bulb 102 does not break, and above the design temperature, the frangible sprinkler bulb 102 breaks, taking less time to break as temperature increases above the design threshold. The sprinkler head 100 further includes a mounting adaptor 109 for connecting with a supply conduit 110. Moreover, the sprinkler head 100 includes a seal 111 for fluidly isolating the frangible sprinkler bulb 102 from the supply conduit 110. When the frangible sprinkler bulb 102 disintegrates, the seal 111 ruptures causing water within the supply conduit 110 to be released at high pressure. The frangible sprinkler bulb 102, disclosed herein, functions both as a tracking device and a fire extinguishing device as will be discussed in detail.

FIG. 1B exemplarily illustrates an enlarged view of the frangible sprinkler bulb 102 of the sprinkler head 100 shown in FIG. 1A. In one or more embodiments, the frangible sprinkler bulb 102 includes a cylindrical wall 103 and a resistive track 104 embedded in the cylindrical wall 103. In one or more embodiments, the resistive track 104 is embedded in the cylindrical wall 103 in a pattern including, for example, but not limited to a serpentine pattern, a periodic waveform pattern, a waveform pattern, and a helical pattern. The resistive track 104 may be etched onto an external surface of the cylindrical wall 103. In other embodiments, the resistive track 104 may be etched along the entire length of the cylindrical wall 103. As exemplarily illustrated in FIGS. 1C-1D, at least one microchip 105 and at least one diode 106 are operationally connected in series to the resistive track 104. Moreover, the at least one microchip 105 and the at least one diode 106 are connected in parallel to each other as exemplarily illustrated in FIGS. 1C-1D. A battery or power source may be electrically coupled to first and second terminals (107, 108) of the resistive track 104 to supply electrical power under control of the microchip 105 to heat the frangible sprinkler bulb 102. The power source may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

FIG. 1C exemplarily illustrates a circuit diagram 150 showing the frangible sprinkler bulb 102 operating in a tracking mode. FIG. 1D exemplarily illustrates a circuit diagram 150 showing the frangible sprinkler bulb 102 operating in a releasing mode. As used herein, “the tracking mode” refers to a mode of operation of the frangible sprinkler bulb 102 in which information is gathered from the frangible sprinkler bulb 102 using the microchip 105. The information may be gathered periodically or at predefined intervals set by an operator. Alternatively, the information may be gathered on demand at random intervals. As used herein, “the releasing mode” refers to a mode of operation of the frangible sprinkler bulb 102 in which the flow of current is reversed in comparison to the flow of current in the tracking mode. Moreover, the current is of a larger magnitude than the current flow in the tracking mode causing the resistive track 104 to heat the cylindrical wall 103 as exemplarily illustrated in FIG. 1B. Referring again to FIGS. 1C-1D, in the tracking mode, a first current flows from the first terminal 107 to the second terminal 108 sequentially through the resistive track 104 and the at least one microchip 105. In the releasing mode, a second current flows from the second terminal 108 to the first terminal 107 sequentially through the at least one diode 106 and the resistive track 104. The second current passing through the embedded resistive track 104 disintegrates the frangible sprinkler bulb 102. The tracking mode and the releasing modes of operation will be explained in detail in the detailed description of FIG. 2.

FIG. 2 exemplarily illustrates a schematic block diagram showing an implementation of a fire detection system 200 according to the disclosure. In an embodiment according to the disclosure, the fire detection system 200 includes the sprinkler head 100 as disclosed in the detailed description of FIG. 1A and control circuitry 201. The sprinkler head 100 is arranged to dispense water in the region 202 when a fire event is detected within the region 202.

As used herein, the term “control circuitry 201” and “microchip 105” May be construed to encompass one or a combination of microprocessors, suitable logic, circuits, audio interfaces, visual interfaces, haptic interfaces, or the like. The control circuitry 201 and the microchip 105 may include, but are not limited to a microcontroller, a Reduced Instruction Set Computing (RISC) processor, an Application-Specific Integrated Circuit (ASIC) processor, a Complex Instruction Set Computing (CISC) processor, a central processing unit (CPU), a graphics processing unit (GPU), a state machine, and/or other processing units 201-1 or circuits. The control circuitry 201 may also comprise suitable logic, circuits, interfaces, and/or code that may be configured to execute a set of instructions stored in a memory unit 201-2. In an exemplary implementation of the memory unit 201-2 according to the disclosure, the memory unit 201-2 May include, but are not limited to, Electrically Erasable Programmable Read-only Memory (EEPROM), Random Access Memory (RAM), Read Only Memory (ROM), Hard Disk Drive (HDD), Flash memory, Solid-State Drive (SSD), and/or CPU cache memory.

The control circuitry 201 further includes a communications unit 201-3 configured to communicate with the microchip 105 and other components of the fire detection system 200 such as sensors within the region 202 and a computing device 203. During the tracking mode, the control circuitry 201 communicates with the microchip 105 in the frangible sprinkler bulb 102 to obtain information related to the frangible sprinkler bulb 102. The information related to the frangible sprinkler bulb 102 includes a location of the frangible sprinkler bulb 102, a temperature of the region 202 surrounding the frangible sprinkler bulb 102, smoke particulate density of the region 202 surrounding the frangible sprinkler bulb 102, a resistance of the resistive track 104, etc. In addition, the information related to the frangible sprinkler bulb 102 includes internal pressure of the frangible sprinkler bulb 102, a temperature of the frangible sprinkler bulb 102, etc. The resistive track 104 is embedded in the cylindrical wall 103 in a pattern including at least one of a serpentine pattern, a periodic waveform pattern, a waveform pattern, and a helical pattern. Since the resistive track 104 is configured in different patterns on different frangible sprinkler bulbs 102, the resistance is different for different frangible sprinkler bulbs 102. This differentiating feature makes each frangible sprinkler bulb 102 of the fire detection system 100 unique and as though having a unique identifying feature. During the tracking mode, the microchip 105 obtains this information and transmits the information to the control circuitry 201. In an exemplary embodiment, the tracking mode is triggered periodically at predefined intervals. As used herein, “predefined intervals” is used to mean a periodic interval such as every second, every 5 seconds, every minute, every hour, and the like. The predefined interval may be stored in the memory unit 201-2 or may be adjusted by an operator using the control circuitry 201. In another embodiment, the tracking mode is triggered based on the control circuitry 201 receiving an input from operators or authorized personnel. The control circuitry 201 is further configured to detect a fire event based on the control circuitry 201 receiving no response or absence of response from the at least one microchip 105 during the tracking mode.

In an embodiment according to the disclosure, the control circuitry 201 is integrated as a part of the fire detection system 200 remote from the sprinkler head 100. Accordingly, the fire detection system 200 may also comprise a plurality of sensors configured to detect one or more parameters of the region 202. In one or more embodiments, the sensors may include one or a combination of temperature sensors, air quality sensors, and the like. Alternatively, the sensors may be installed as a part of a building management system or other Heating, Ventilating and Air Conditioning system. Using these sensors, the control circuitry 201 and/or the microchip 105 detects information regarding different parameters of the region 202. These include but are not limited to the temperature of the region 202 surrounding the frangible sprinkler bulb 102, smoke particulate density of the region 202 surrounding the frangible sprinkler bulb 102, humidity, and the like. During the tracking mode, once the control circuitry 201 or the microchip 105 determines feedback from the sensors exceeds at least one predefined criteria, the control circuitry 201 transmits a trigger signal to the microchip 105 to actuate the releasing mode. As used herein, “predefined criteria” includes threshold values of the temperature of the region 202 surrounding the frangible sprinkler bulb 102, smoke particulate density of the region 202 surrounding the frangible sprinkler bulb 102, internal pressure of the frangible sprinkler bulb 102, etc. During the releasing mode, the control circuitry communicates with the at least one microchip 105 in the frangible sprinkler bulb 102 to trigger the second current based on the determined resistance of the resistive track 104. Since the resistance is different for different frangible sprinkler bulbs 102, the current flow should be sufficient to raise the temperature to a magnitude sufficient to rupture the cylindrical wall 103 exemplarily illustrated in FIG. 1B. In yet another embodiment, the releasing mode is triggered based on the control circuitry 201 receiving an input from an operator or a user of the fire detection system 200.

In one or more embodiments, the communications unit 201-3 also transmits data to and receives data from the computing device 203 via a communications network 204. The communications unit 201-3 May be configured of, for example, a telematic transceiver (DCM), a mayday battery, a GPS, a data communication module ASSY, a telephone microphone ASSY, and a telephone antenna ASSY. The communications network 204 may include, but is not limited to, a Wide Area Network (WAN), a cellular network, such as a 3G, 4G, or 5G network, an Internet-based mobile ad hoc networks (IMANET), etc. The communications network 204 may also include wired media such as a wired network or direct-wired connection, and wireless media such as acoustic, radio frequency (RF), microwave, infrared (IR) and other wireless media. In one or more embodiments, the computing device 203 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions.

The computing device 203 may also be implemented as a personal computer including both laptop computer and non-laptop computer configurations. The computing device 203 can also be any type of network computing device. The computing device 203 can also be an automated system as described herein. The computing device 203 may have additional features or functionality, and additional interfaces to facilitate communications between basic configuration and any devices and interfaces. For example, a bus/interface controller may be used to facilitate communications between a basic configuration and one or more data storage devices via a storage interface bus. Data storage devices may be removable storage devices, non-removable storage devices, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and non-volatile, removable and non-removable media implemented in any method or technology for storage of information, such as computer readable instructions, data structures, program modules, or other data systems can also be used for data analysis and to determine when (e.g., acceleration and/or speed).

When a fire event is detected or the releasing mode is triggered in at least one of the frangible sprinkler bulbs 102, the communications unit 201-3 of the control circuitry 201 generates a trigger signal which is conveyed to an interface or communications unit of the computing device 203. When the computing device 203 receives the trigger signal, the computing device 203 generates a notification such as an audio notification, a visual notification, and audio-visual notification, and a haptic notification. The audio notification may include a loud warning siren or alarm which may be generated for a continuous or periodic interval of time. The audio notification is configured to be cleared or switched off based on an input received via the computing device 203, after which time the computing device 203 resumes to a normal indication without the emergency audio notification. The input may include an input received via a haptic interface of the computing device 203, an ON/OFF switch, biometric/RFID authentication by authorized security or safety personnel, etc. This means the audio notification provides the alert continuously to the operator of the computing device 203 until the operator shuts off the notification. In some exemplary implementations according to the disclosure, the computing device 203 generates a visual notification in addition to the audio notification via a display interface of the computing device 203.

The display may comprise suitable logic, circuitry, interfaces, and/or code that may be configured to render various types of information and/or entertainment content via a user interface. In one or more embodiments, the display may be a flashing visual indicator, such as a Light Emitting Diode (LED), indicator lights, or the like. The user interface may be a customized Graphic User Interface (GUI) configured to display information related to the fire detection system 200 such as the predefined criteria set by the operator, location of the fire, number of damaged frangible sprinkler bulbs 102, etc. The display may include but is not limited to a projection-based display, an electro-chromic display, a flexible display, and/or holographic display. In other embodiments, the display may be a touchscreen display, a tactile electronic display, and/or a touchable hologram. As such, the display may be configured to receive inputs from the operator for setting or modifying the predefined criteria, the predefined intervals, etc. In one or more embodiments, the authorized personnel/operator may be prompted to clear the audio or visual notification. Alternately, the audio notification, the visual notification, or the audio-visual notification is configured to stop only based on an input received from the operator via the computing device 203. Consequently, the computing device 203 configures the audio interface and/or the display interface to return to a normal indication mode.

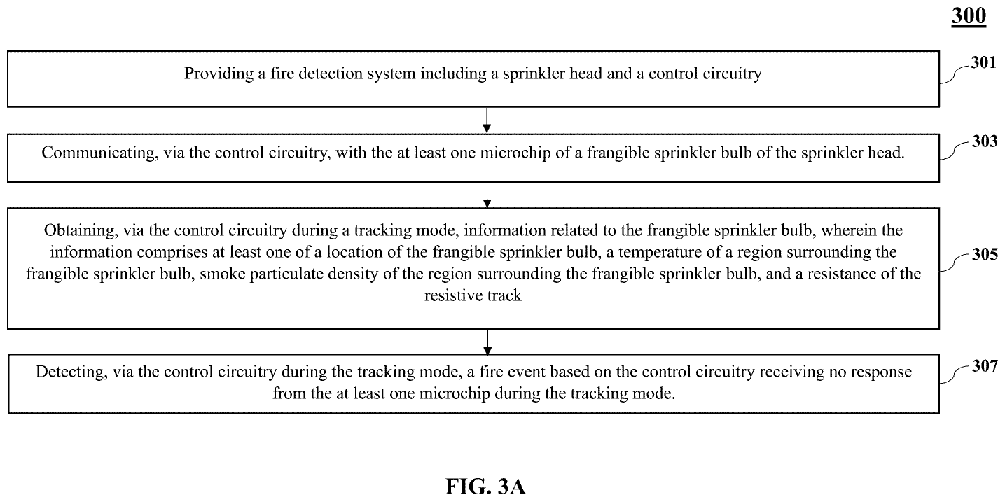

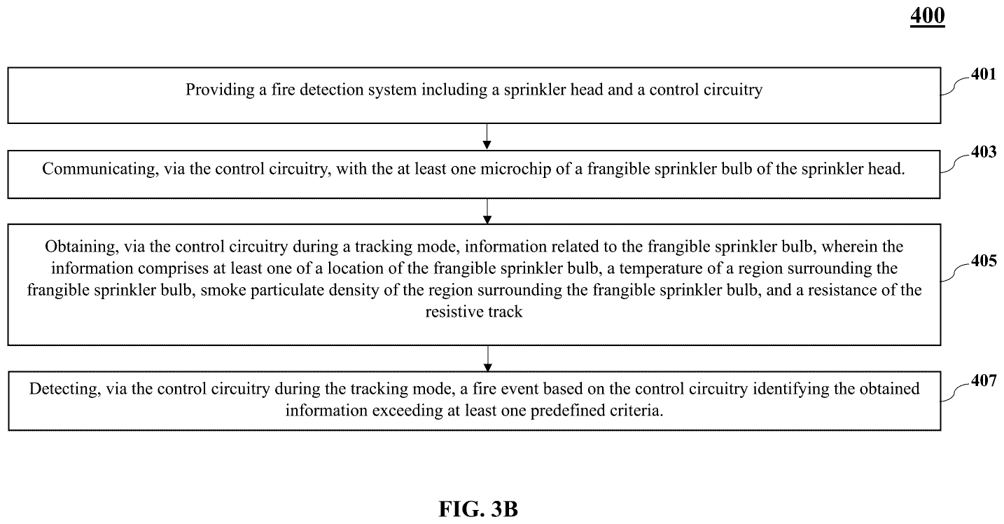

FIG. 3A exemplarily illustrates a flowchart indicating a fire detection method 300 using the fire detection system 200 shown in FIG. 2.

In the fire detection method 300, disclosed herein, at Step 301, the fire detection system 200 is provided as disclosed in the detailed description of FIG. 2. The fire detection system 200 includes the sprinkler head 100 and the control circuitry 201. The sprinkler head 100 includes the sprinkler body 101 and the frangible sprinkler bulb 102 connected to the sprinkler body 101 as disclosed in the detailed description of FIGS. 1A-1B. The frangible sprinkler bulb 102 includes the resistive track 104 embedded in the cylindrical wall 103. The at least one microchip 105 and the at least one diode 106 are operationally connected in series to the resistive track 104. Further, the at least one microchip 105 and the at least one diode 106 are connected in parallel to each other. In one or more embodiments, the fire detection system 200 may comprise a plurality of sprinkler heads 100, such that each sprinkler head 100 is as described in the detailed descriptions of FIGS. 1A-1D.

In the fire detection method 300, at Step 303, the control circuitry 201 of the fire detection system 200 communicates with the at least one microchip 105 of the frangible sprinkler bulb 102.

At Step 305, during a tracking mode, the control circuitry 201 of the fire detection system 200 obtains information related to the frangible sprinkler bulb 102. The information includes at least one of a location of the frangible sprinkler bulb 102, a temperature of the region 202 surrounding the frangible sprinkler bulb 102, smoke particulate density of the region 202 surrounding the frangible sprinkler bulb 102, and a resistance of the resistive track 104.

At Step 307, during the tracking mode the control circuitry 201 detects a fire event based on the control circuitry 201 receiving no response or absence of response from the at least one microchip 105.

FIG. 3B exemplarily illustrates a flowchart indicating a fire detection method 400 using the fire detection system shown in FIG. 2.

In the fire detection method 400, disclosed herein, at Step 401, the fire detection system 200 is provided as disclosed in the detailed description of FIG. 2. The fire detection system 200 includes the sprinkler head 100 and the control circuitry 201. The sprinkler head 100 includes the sprinkler body 101 and the frangible sprinkler bulb 102 connected to the sprinkler body 101 as disclosed in the detailed description of FIGS. 1A-1B. The frangible sprinkler bulb 102 includes the resistive track 104 embedded in the cylindrical wall 103. The at least one microchip 105 and the at least one diode 106 are operationally connected in series to the resistive track 104. Further, the at least one microchip 105 and the at least one diode 106 are connected in parallel to each other. In one or more embodiments, the fire detection system 200 may comprise a plurality of sprinkler heads 100, wherein each sprinkler head 100 is as described in the detailed descriptions of FIGS. 1A-1D.

In the fire detection method 400, at Step 403, the control circuitry 201 of the fire detection system 200 communicates with the at least one microchip 105 of the frangible sprinkler bulb 102.

At Step 405, during a tracking mode, the control circuitry 201 of the fire detection system 200 obtains information related to the frangible sprinkler bulb 102. The information includes at least one of a location of the frangible sprinkler bulb 102, a temperature of the region 202 surrounding the frangible sprinkler bulb 102, smoke particulate density of the region 202 surrounding the frangible sprinkler bulb 102, and a resistance of the resistive track 104.

At Step 407, during the tracking mode the control circuitry 201, detects the fire event based on the control circuitry 201 identifying the obtained information exceeding at least one predefined criteria. In one or more embodiments, the control circuitry 201 is further configured to trigger a releasing mode based on the control circuitry 201 identifying the obtained information exceeding the at least one predefined criteria. The releasing mode may also be triggered based on the control circuitry 201 receiving an input. The control circuitry 201 is further configured to generate a notification on the computing device 203 when the releasing mode is triggered or the fire event is detected as disclosed in the detailed description of FIG. 2. In one or more embodiments, the notification is, for example, an audio notification, a visual notification, an audio-visual notification, a haptic notification, and the like.

Referring to FIGS. 1-3B , the sprinkler head 100, disclosed herein, has a reduced production time since the resistive track 104 and the microchip 105 are embedded on the external surface of existing frangible sprinkler bulbs 102. This means no complex additional components/wiring or modification in the existing frangible sprinkler bulbs 102 are made to implement the improved fire detection system 200. As such, the cost and complexity of the improved sprinkler head 100 are reduced. Furthermore, since the resistive track 104 is embedded directly on the external surface of the frangible sprinkler bulb 102, the heat transfer is improved thereby increasing reliability of disintegration of the frangible sprinkler bulbs 102 in the event of a fire. Moreover, since the tracking mode and releasing modes of the frangible sprinkler bulbs 102 are isolated from the functioning of a water distribution system, the reliability of the fire detection system 200 is further increased. The tracking modes can be activated from a factory or manufacturing facility to improve tracking of the frangible sprinkler bulbs 102 during transit from production till installation.

As would be apparent to a person in the art, various working modifications may be made to the method in order to implement the inventive concept as taught herein.

Moreover, the actions of any flow diagram need not be implemented in the order shown; nor do all of the acts necessarily need to be performed. Also, those acts that are not dependent on other acts may be performed in parallel with the other acts.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, or essential feature or component of any or all the claims.

What is claimed is:

1. A sprinkler head comprising:
a sprinkler body; and
a frangible sprinkler bulb connected to the sprinkler body, the frangible sprinkler bulb comprising:
a cylindrical wall;
a resistive track embedded in the cylindrical wall; and
at least one microchip and at least one diode operationally connected in series to the resistive track, the at least one microchip and the at least one diode connected in parallel to each other,
wherein, in a tracking mode, a first current flows from a first terminal to a second terminal sequentially through the resistive track and the at least one microchip,
and wherein, in a releasing mode, a second current flows from the second terminal to the first terminal sequentially through the at least one diode and the resistive track.

2. The sprinkler head as claimed in claim 1, further comprising a mounting adaptor for connecting with a supply conduit.

3. The sprinkler head as claimed in claim 2, further comprising a seal for fluidly isolating the sprinkler bulb from the supply conduit.

4. The sprinkler head as claimed in claim 1, wherein the resistive track is embedded in the cylindrical wall in a pattern comprising at least one of a serpentine pattern, a periodic waveform pattern, a waveform pattern, and a helical pattern.

5. The sprinkler head as claimed in claim 1, wherein in the releasing mode, the second current passing through the embedded resistive track disintegrates the frangible sprinkler bulb.

6. A fire detection system comprising:
a sprinkler head comprising:
a sprinkler body; and
a frangible sprinkler bulb connected to the sprinkler body, the frangible sprinkler bulb comprising:
a cylindrical wall;
a resistive track embedded in the cylindrical wall; and
at least one microchip and at least one diode operationally connected in series to the resistive track, the at least one microchip and the at least one diode connected in parallel to each other; and
a control circuitry configured to:
communicate, during the tracking mode, with the at least one microchip in the sprinkler bulb to obtain information related to the sprinkler bulb, wherein the information comprises at least one of a location of the sprinkler bulb, a temperature of a region surrounding the sprinkler bulb, smoke particulate density of the region surrounding the sprinkler bulb, and a resistance of the resistive track; and
communicate, during the releasing mode, with the at least one microchip in the sprinkler bulb to trigger the second current based on the determined resistance of the resistive track.

7. The system as claimed in claim 5, wherein the resistive track is embedded in the cylindrical wall in a pattern comprising at least one of a serpentine pattern, a periodic waveform pattern, a waveform pattern, and a helical pattern.

8. The system as claimed in claim 6, wherein the releasing mode is triggered based on the control circuitry receiving an input.

9. The system as claimed in claim 6, wherein the releasing mode is triggered based on the control circuitry identifying the obtained information exceeding at least one predefined criteria.

10. The system as claimed in claim 6, wherein the control circuitry is further configured to detect a fire event based on the control circuitry receiving absence of response from the at least one microchip during the tracking mode.

11. The system as claimed in claim 6, wherein the tracking mode is triggered periodically at predefined intervals.

12. The system as claimed in claim 6, wherein the tracking mode is triggered based on the control circuitry receiving an input.

13. The system as claimed in claim 6, wherein the control circuitry is further configured to generate a notification on a computing device based on at least one of triggering of the releasing mode and detection of the fire event.

14. The system as claimed in claim 13, wherein the notification is one of an audio notification, a visual notification, an audio-visual notification, and a haptic notification.

15. A method for detecting fire comprising:
providing a fire detection system comprising:
the sprinkler head of claim 3; and
a control circuitry; and
communicating, via the control circuitry, with at least one microchip of a frangible sprinkler bulb;
obtaining, via the control circuitry during a tracking mode, information related to the frangible sprinkler bulb, wherein the information comprises at least one of a location of the frangible sprinkler bulb, a temperature of a region surrounding the frangible sprinkler bulb, smoke particulate density of the region surrounding the frangible sprinkler bulb, and a resistance of the resistive track; and
detecting, via the control circuitry during the tracking mode, a fire event based on the control circuitry receiving absence of response from the at least one microchip during the tracking mode.

16. A fire detection method comprising:
providing a fire detection system comprising:
the sprinkler head of claim 3; and
a control circuitry; and
communicating, via the control circuitry, with the at least one microchip of the frangible sprinkler bulb;
obtaining, via the control circuitry during a tracking mode, information related to the frangible sprinkler bulb, wherein the information comprises at least one of a location of the frangible sprinkler bulb, a temperature of a region surrounding the frangible sprinkler bulb, smoke particulate density of the region surrounding the frangible sprinkler bulb, and a resistance of the resistive track; and
detecting, via the control circuitry during the tracking mode, a fire event based on the control circuitry identifying the obtained information exceeding at least one predefined criteria.

17. The method as claimed in claim 15, wherein the control circuitry is further configured to trigger a releasing mode based on the control circuitry identifying the obtained information exceeding the at least one predefined criteria.

18. The method as claimed in claim 17, wherein the releasing mode is triggered based on the control circuitry receiving an input.

19. The method as claimed in claim 15, wherein the control circuitry is further configured to generate a notification on a computing device based on at least one of triggering of the releasing mode and detection of the fire event.

20. The method as claimed in claim 19, wherein the notification is one of an audio notification, a visual notification, an audio-visual notification, and a haptic notification.
